(19) United States
(12) Patent Application Publication
(10) Pub. No.: US 2015/0025997 A1
(43) Pub. Date: Jan. 22, 2015

(54) SOCIAL COACHING SYSTEM

(71) Applicants: Stephanie Tilenius, San Francisco, CA (US); Jonatha Chan, San Francisco, CA (US); Ozan Onay, San Francisco, CA (US)

(72) Inventors: Stephanie Tilenius, San Francisco, CA (US); Jonatha Chan, San Francisco, CA (US); Ozan Onay, San Francisco, CA (US)

(21) Appl. No.: 14/333,447

(22) Filed: Jul. 16, 2014

Related U.S. Application Data
(60) Provisional application No. 61/846,737, filed on Jul. 16, 2013.

(51) Int. Cl. G06Q 30/06; G06Q 50/22; G06F 17/30

(52) U.S. Cl. CPC G06Q 30/0631; G06F 17/3097; G06F 17/3053; G06Q 50/22
USPC 705/26.7

(57) ABSTRACT

In example embodiments, a system and method for providing a social coaching system is provided. A coach database is maintained by the coaching system. The coach database includes a list of coaches and attributes associated with each coach on the list. A request for a coach is received. The request includes at least one goal of a consumer. A plurality of coaches specializing in achieving the at least one goal is determined. The coach may be determined by identifying a match between the attributes associated with each coach and the goals of the consumer. A recommendation indicating the plurality of coaches is provided to the consumer. A selection of the coach from the recommendation is received. The coach is then assigned to the consumer.

### CROSS REFERENCE TO RELATED APPLICATION

The present application claims the priority benefit of U.S. Provisional Patent Application Ser. No. 61/846,737, filed on Jul. 16, 2013 and entitled “Social Coaching System,” which is incorporated herein by reference in its entirety.

### TECHNICAL FIELD

This patent document pertains generally to computing devices and, in example embodiments, to providing health and fitness coaching on one or more computing devices.

### BRIEF DESCRIPTION OF DRAWINGS

Some embodiments are illustrated by way of example and not limitation in the figures of the accompanying drawings in which:

FIG. 1 is a diagrammatic representation of a networked computing environment providing a health coaching system, according to an example embodiment, that may be deployed.

FIG. 2 is a block diagram showing a device having a coaching application embodied thereon, according to an example embodiment.

FIG. 3A is a block diagram showing an example coaching server.

FIG. 3B is a block diagram of an example consumer engine of the coaching server.

FIG. 3C is a block diagram of an example coach engine of the coaching server.

FIG. 4 is an interface diagram illustrating a goal setting screen presented to a consumer, according to an example embodiment.

FIG. 5A is an interface diagram illustrating a coach recommendation screen presented to the consumer, according to an example embodiment.

FIG. 5B is an alternative interface diagram illustrating a coach recommendation screen presented to the consumer, according to an example embodiment.

FIG. 6 is an interface diagram illustrating a team screen presented to the consumer, according to an example embodiment.

FIG. 7 is an interface diagram illustrating another team screen presented to the consumer, according to an example embodiment.

FIG. 8 is an interface diagram illustrating a following screen presented to the consumer, according to an example embodiment.

FIG. 9 is an interface diagram illustrating a status screen presented to the consumer, according to an example embodiment.

FIG. 10 is an interface diagram illustrating another status screen presented to the consumer, according to an example embodiment.

FIG. 11 is an interface diagram illustrating another status screen presented to the consumer, according to an example embodiment.

FIG. 12 is an interface diagram illustrating a summary screen presented to the coach, according to an example embodiment.

FIG. 13 is an interface diagram illustrating another summary screen presented to the coach, according to an example embodiment,

FIG. 14 is an interface diagram illustrating a messaging screen presented to the consumer, according to an example embodiment.

FIG. 15 is an interface diagram illustrating a content card screen presented to a coach, according to an example embodiment.

FIG. 16 is a flowchart of an example method of assigning a coach to a consumer.

FIG. 17 is a flowchart of an example method of providing status and detail interfaces.

FIG. 18 is a block diagram of a machine, in the example form of a computer system, within which a set of instructions may be executed for causing the machine to perform any one or more of the methodologies discussed herein.

### DETAILED DESCRIPTION

In the following description, for purposes of explanation, numerous specific details are set forth in order to provide a thorough understanding of some example embodiments. It will be evident, however, to one skilled in the art that the present inventive subject matter may be practiced without these specific details.

In example embodiments, a system and method for providing a social coaching system is described. A coach database is maintained by the coaching system. The coach database includes a list of coaches and attributes associated with each coach on the list. The coaches may comprise fitness and health coaches, nurse practitioners, doctors, or other health care professionals. A request for a coach is received. The request includes at least one goal of a consumer. In example embodiments, the goal is a health or physical fitness goal. A plurality of coaches specializing in achieving the at least one goal is determined. The coach may be determined by identifying a match between the attributes associated with each coach and the goals of the consumer. A recommendation indicating the plurality of coaches is provided to the consumer. A selection of the coach from the recommendation is received. The coach is then assigned to the consumer.

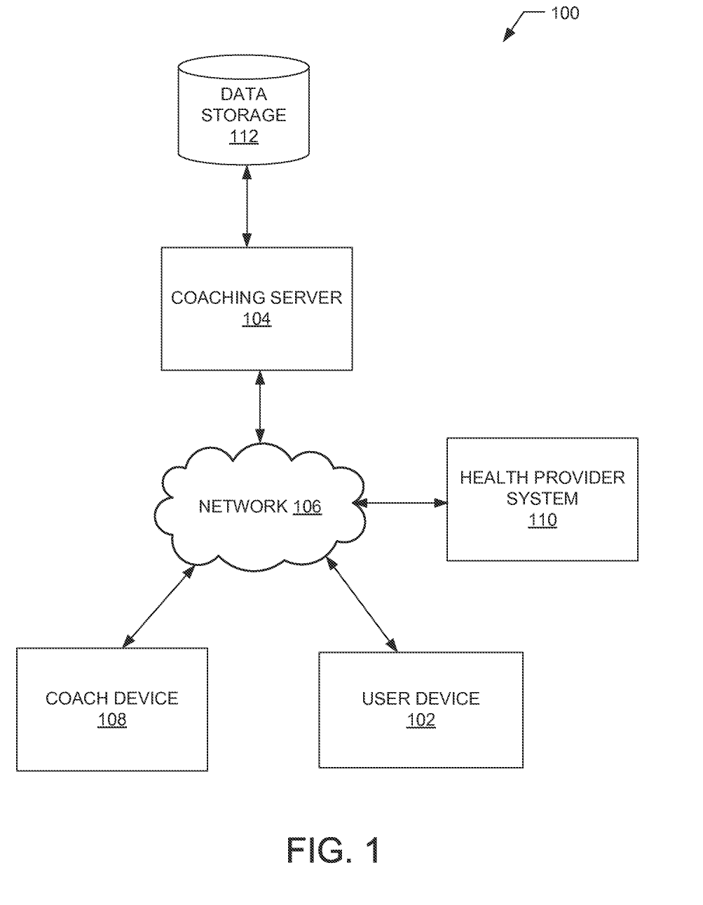

FIG. 1 is a diagrammatic representation of a network environment 100 providing a health coaching system, according to an example embodiment. In example embodiments, a mobile coaching application (e.g., an iOS or Android application) operating on a user device 102 of a consumer interacts with a coaching server 104 via a network 106. The consumer is a user (e.g., a person) that desires to have instant access to a coach and to health and fitness information via the coaching server 104. The coaching server 104 provides a mobile marketplace of coaches from which the consumer may select his or her coach. Additionally, the coaching server 104 provides health and fitness monitoring services along with access to general health information and health programs. For example, a consumer with diabetes may select a coach (e.g., a doctor or nurse practitioner) that specializes in the management of diabetes. The coach may then assist the consumer in managing medication, sleep, exercise, food, and other lifestyle components to manage or reverse the effects of the particular medical condition.

In some example embodiments, the coaching application on the user device 102 and the coaching server 104 (e.g., implemented as a cloud-based system) are automatically synchronized in real time. The coaching application and the coaching server 104 may collectively be viewed as constituting all or part of a coaching system (e.g., a social coaching system, a health coaching system, or any suitable combination thereof). While functionality may be described as being provided by either the coaching application or the coaching server 104, it should be appreciated that certain functionality is interchangeable between the coaching server 104 and the coaching application on the user device 102, and may be implemented as part of either component, or even divided between the coaching server 104 and the user device 102 of the consumer.

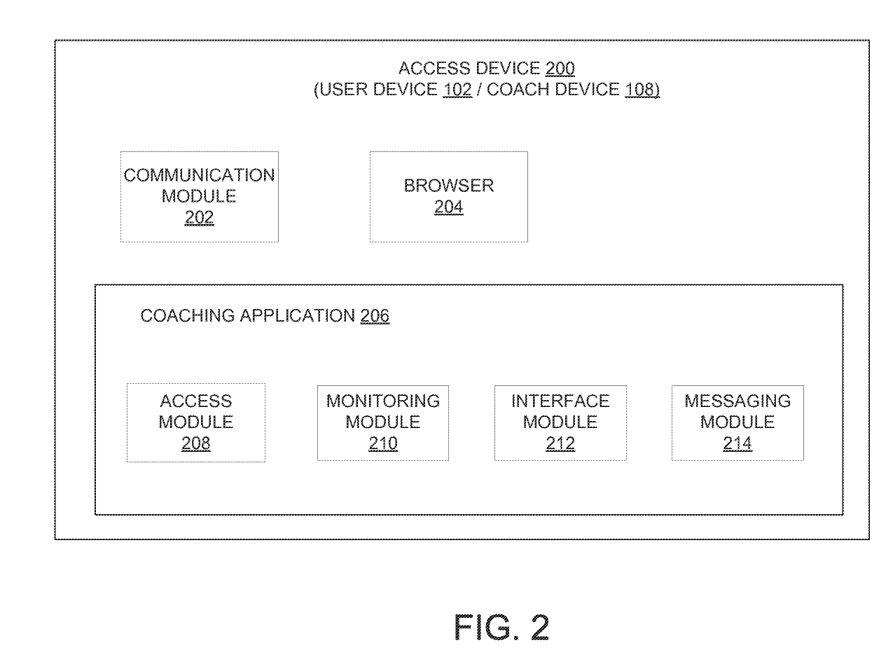

The networked environment 100 also comprises a coach device 108 communicatively coupled via the network 106 to the coaching server 104. The coach device 108 is used by the coach to manage, monitor, and communicate with one or more consumers assigned to the coach. The coach device 108 also comprises a coaching application to enable the coach to access data pertaining to his or her clients (e.g., assigned consumers). The coach can, using the coach device 108, provide advice (e.g., instruction and encouragement), provide a comment on the consumer's successes and behaviors, provide congratulations (e.g., high-five) to the consumer, and recommend ideas and suggestions to the consumer (e.g., exercise plan). The user device 102 and the coach device 108 will be discussed in more detail in connection with FIG. 2.

The network environment 100 may also comprise a health provider system 110. In example embodiments, the health provider system 110 may be a server or computing system associated with a doctor, hospital, clinic, pharmacy, or any other medical service provider. The health provider system 110 may provide health information of the consumer to the coaching server 104. For example, the health provider system 110 may provide biometrics, blood work, clinical data, phenotype data, and longer term genomic data of the consumer to the coaching server 104. Additionally, the health provider system 110 may provide recommendations for the consumer (also referred to as “health information”). For example, the health provider system 110 may recommend the health or fitness goals for the consumer (e.g., consumer should lose 20 pounds, consumer should have exercise and diet regiment to reverse effects of diabetes) or recommend dietary constraints or exercise plans. These recommendations may come from, for example, a doctor associated with the health provider system 110 that is the doctor for the consumer. The health information may be stored to a data record associated with the consumer in a data storage 112, and may be used by the coaching server 104 to determine a status for the consumer, as will be discussed further below.

The data storage 112 may also comprise a coach database. The coach database may include attributes for each coach and a coach profile (e.g., description of the coach). The attributes may indicate specialties of the coach such as, for example, weight loss, diabetes prevention or reversal, stress management, strength training, and other health or medical condition prevention, reversal, or management.

The data storage 112 may further comprise a user profile database that maintains a user profile for each consumer. In example embodiments, the consumer may selectively share personal data (e.g., nutrition, sleep, and exercise) with the selected coach or other members of the coaching system (e.g., other consumers that use the coaching system). Accordingly, the consumer may provide the personal data as user inputs to the coaching server 104. The user inputs may then be stored to the data records of the consumer or the user profile in the data storage 112.

It is noted that the network environment 100 shown in FIG. 1 is merely an example. For instance, alternative embodiments may comprise any number of user devices 102, coach devices 108, health provider systems 110, or data storage 112 in the network environment 100. Additionally, while the data storage 112 is shown as being coupled to the coaching server 104, the data storage 112 may, alternatively, be embodied within the coaching server 104 or be accessible to the coaching server 104 through the network 106.

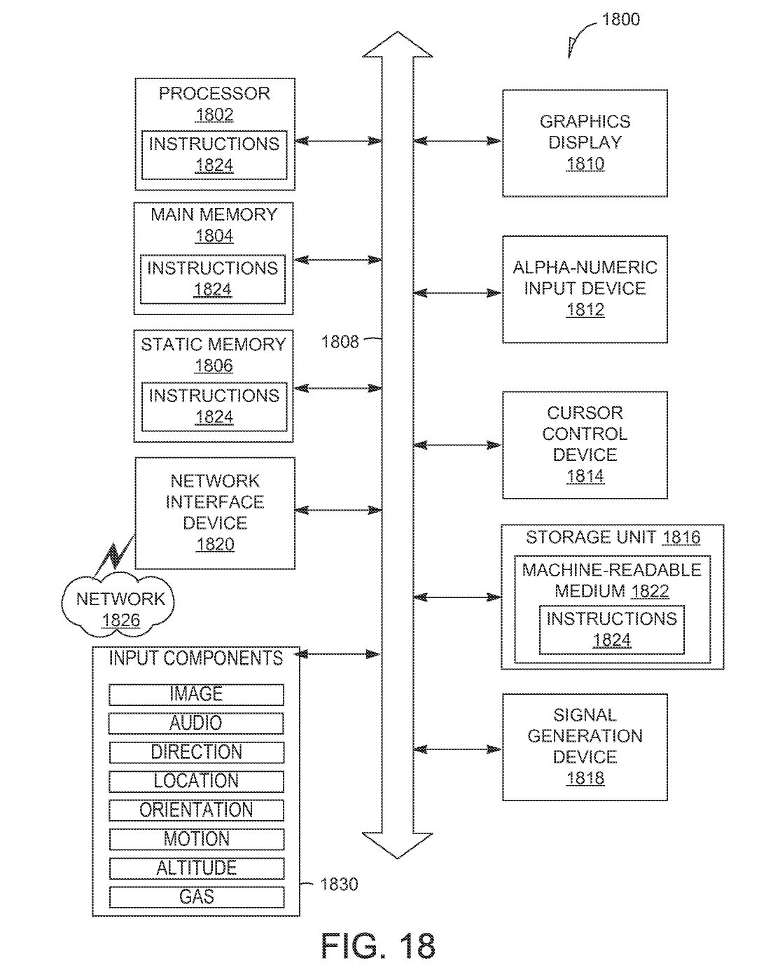

Furthermore, any of the machines or devices shown in FIG. 1 may be implemented in a general-purpose computer modified (e.g., configured or programmed) by software (e.g., one or more software modules) to be a special-purpose computer to perform one or more of the functions described herein for that machine, database, or device. For example, a computer system able to implement any one or more of the methodologies described herein is discussed below with respect to FIG. 18. Moreover, any two or more of the machines or devices illustrated in FIG. 1 may be combined into a single machine, and the functions described herein for any single machine or device may be subdivided among multiple machines or devices.

FIG. 2 is a block diagram showing an access device 200 having a coaching application 206 embodied thereon, according to an example embodiment. The access device 200 may be the user device 102 or the coach device 108. For example, the access device 200 may be a smartphone, a desktop computer, a vehicle computer, a tablet computer, a portable media device, a wearable device (e.g., a smart watch or smart glasses), or any other device capable of making a communicating via the network 106. In example embodiments, the access device 200 comprises a communication module 202, a browser 204, and the coaching application 206. The coaching application 206 may be stored in a memory or storage of the access device 200. In some example embodiments, the coaching application 206 may be the same for the consumer (e.g., as installed on the user device 102) and the coach (e.g., as installed on the coach device 108). In other example embodiments, the coaching application 206 may be different for each of the consumer and the coach. Not all components shown in FIG. 2 may be present in or used by the access device 200.

The communication module 202 manages the exchange of communications for the access device 200. For example, the communication module 202, may receive a call or text or send a call or text between the consumer and the coach or between the consumer and other consumers (e.g., team members). Other communication mechanism may also be exchanged via the communication module 202. For example, video messaging may be used between the consumer and his or her coach.

The browser 204 provides access to content on the Internet through the network 106. In particular, the browser 204 may provide, locate, retrieve, and display content from the coaching server 104. For example, the coach via the coach device 108 may access a web-based coaching interface provided by the coaching server 104. Using the web-based coaching interface, the browser 204 on the coach device 108 may present various user interfaces to the coach that allows the coach to perform various operations such as, monitor his or her clients (e.g., consumers assigned to the coach) and send messages to his or her clients.

Thus, the coaching application 206 may work in conjunction with the browser 204 to allow the consumer or the coach to interact with the coaching server 104 via a network 106. In some example embodiments, the coaching application 206 on the user device 102 may automatically synchronize real time with the coaching server 104 and may provide instant access to health information, personal health plans, status, and coaching by the coach. Accordingly, the coaching application 206 may comprise an access module 208, a monitoring module 210, an interface module 212, and a messaging module 214. In alternative embodiments, some of the modules of the coaching application 206 may be located outside of the coaching application 206 on the access device 200 or be located at the coaching server 104.

The access module 208 provides access to user data at the coaching server 104. Because the data may be private data regarding, for example, nutrition, sleep, exercise, health issues, and personal biometrics, access my be restricted. The access module 208 may require that the consumer provide login credentials in order to launch the coaching application 206 or access data from the coaching server 104. The login credential may comprise a password, personal identification number (PIN), or other unique identifier or access code that is compared, by the access module 208, to a stored version. Based on a match, the consumer or coach is allowed to launch the coaching application 206 or access data from the coaching server 104.

The monitoring module 210 manages the monitoring of the consumer. In some embodiments, the monitoring module 210 may automatically detect user inputs to be provided to the coaching server 104. For example, if the consumer is wearing a monitoring device (e.g., wristband tracker device), the monitoring device may provide exercise data to the monitoring module 210 (e.g., thru Bluetooth communications). Alternatively, the monitoring device may report data directly to the coaching server 104. In some cases, the access device 200 may be the monitoring device, itself.

The interface module 212 may provide or display various user interfaces to the consumer that enables the consumer to provide user inputs and to monitor their status on the coaching system using the user device. Alternatively, the interface module 212 may provide various user interfaces to the coach that enables the coach to provide data to the coaching system and to monitor his or her clients.

The messaging module 214 manages the exchange of messages between the consumer, the coach, and fellow team members, if the consumer is a member of a team. Accordingly, the messaging module 214 may provide a messaging interface that allows the consumer or coach to generate and send messages, as well as to display incoming messages. The messages may comprise, for example, e-mails, text messages, short message service (SMS) messages, or any other form of communication supported by the access device 200. Additionally, the messaging module 214 may facilitate phone calls or video conferences between the consumer and the coach. As a result, the consumer may have instant access to a coach (e.g., health care provider such as a doctor or nurse practitioner′) at any time.

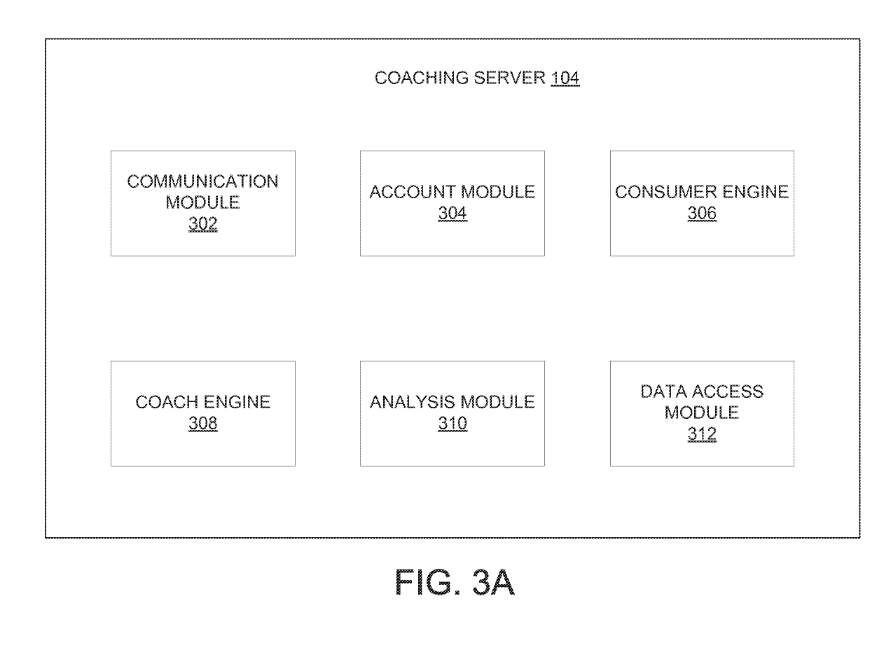

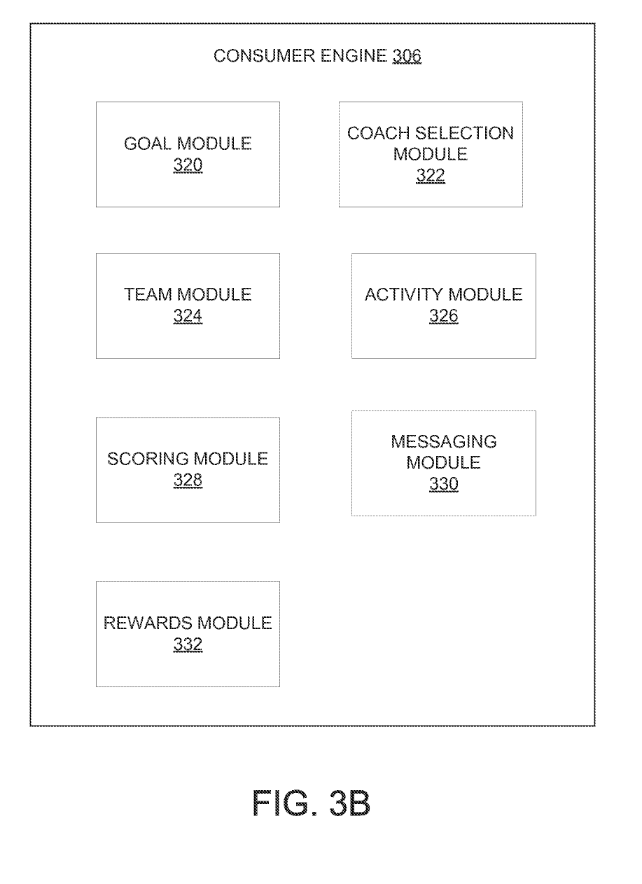

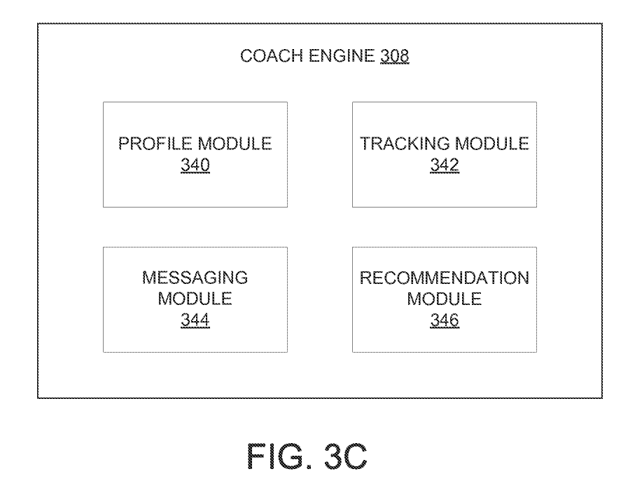

Referring now to FIG. 3A, a block diagram of the coaching server 104, in accordance with one example embodiment, is shown. The coaching server 104 provides a marketplace of coaches from which the consumer may select a coach. Additionally, the coaching server 104 provides health and fitness monitoring services along with access to general health information and health programs. Furthermore, the coaching server 104 allows establishment of teams of consumers, so that team members may, for example, provide support to each other in achieving their goals (e.g., weight loss or reversing the effects of an illness). Accordingly, the coaching server 104 may comprise a communication module 302, an account module 304, a consumer engine 306, a coach engine 308, an analysis module 310, and a data access module 312, all communicatively coupled together.

The communication module 302 manages the exchange of communications for the coaching server 104. For example, the communication module 302 may receive account set up requests from one or more consumers and coaches, access requests from one or more consumers and coaches for status information, questionnaire answers from one or more coaches, and health information from the health provider system 110. Conversely, the communication module 302 may transmit, for example, requested data (e.g., status information of a consumer or team) to the one or more consumers or coaches, account information, or health programs and plans.

The account module 304 manages accounts at the coaching server 104. In example embodiments, the account module 304 may establish accounts for one or more consumers and coaches. For example, the consumer may indicate a desire to establish a consumer account and provide contact, billing, and login credentials to the account module 304 in order to establish the consumer account. Similarly, a coach may indicate a desire to establish a coach account and provide contact, billing, and login credentials to the account module 304. Additionally, the coach may be required to provide license information, certification information, or training information to the account module to be verified as a coach. The account module 304 further maintains the accounts of the one or more consumers and coaches (e.g., update account information), and may close an account for various reasons.

The consumer engine 306 provides functionalities related to the consumer at the coaching server 104. The consumer engine 306 will be discussed in more detail in connection with FIG. 3B below.

The coach engine 308 provides functionalities related to the coach at the coaching server 104. The coaching engine 3085 will be discussed in more detail in connection with FIG. 3C below.

The analysis module 310 performs analysis of data, such as user inputs provided by the consumer and health information provided by the health provider system 110, to determine status information for the consumer. The status information may indicate progress in reaching one or more goals indicated by the consumer. The status information may be shared with the coach of the consumer, as well as with fellow team members of the consumer. In various embodiments, the consumer may determine who may view their status information. For example, one set of team members may be allowed to see all status information, while a second set of team members may be allowed to only view a portion of the status information. Further still, the consumer may indicate other users that may be allowed to view their status information. For example, the coaching system may connect to various social networking platforms (e.g., to Facebook and Twitter) or the consumer may identify “friends” that are allowed access. Additionally, the consumer may invite friends to join the team.

In one embodiment, the analysis module 310 may be modular and can be customized to an individual consumer and their stated goals. For example, a consumer that is diabetic may track blood sugar, while a consumer that has a weight loss goal without diabetes may not track blood sugar. As such, the analysis module 310 may modify the types of activities that it analyses and tracks based on the goals of the consumer. Accordingly, the status information presented by the analysis module 310 may also differ based on the consumer and their goals.

The data access module 312 accesses data from the data storage 112 for use by the coaching server 104. In one embodiment, the data access module 312 may be a database server. The data storage 112 may include a database of coaches that comprises attributes for each coach and a coach profile (e.g., description of the coach). The attributes may indicate specialties of the coach such as, for example, weight loss, diabetes prevention or reversal, stress management, and strength training. Attributes may also include location of the coach, training style, background information, or any other information that will distinguish one coach from another. Additionally, the data storage 112 may comprise user profiles for each consumer as corresponding data records (e.g., logs of user input and other information). The user profiles and data records may include or be linked to private data (e.g., nutrition, sleep, and exercise) gathered from or for the consumer (e.g., from user inputs, monitoring devices, or health service providers).

In example embodiments, the coaching server 104 provides a backend customer relationship management (CRM) system that is modular. For example, a coach may customize a program for a diabetic. Alternatively, a healthcare profession can create protocols, content, and programs for individual consumers across a range of health conditions. In one embodiment, an open application programming interface (API) may be provided by the coaching server 104 to allow the coaches to perform these operations.

Although the various components of the coaching server 104 have been discussed in terms of a variety of individual modules and engines, a skilled artisan will recognize that many of the items can be combined or organized in other ways and that not all modules or engines need to be present or implemented in accordance with example embodiments. Furthermore, not all components of the coaching server 104 have been included in FIG. 3A. In general, components, protocols, structures, and techniques not directly related to functions of exemplary embodiments have not been shown or discussed in detail. The description given herein simply provides a variety of exemplary embodiments to aid the reader in an understanding of the systems and methods used herein.

Referring now to FIG. 3B, a block diagram of the consumer engine 306, in accordance with one example embodiment, is shown. The example consumer engine 306 provides functionalities related to the consumer at the coaching server 104. Accordingly, the consumer engine 306 may comprise a goal module 320, a coach selection module 322, an activity module 332, a team module 324, a scoring module 326, a messaging module 328, and a rewards module 330, which may all be communicatively coupled together.

The goal module 320 manages a consumer's health goals in using the coaching system. When the consumer initially creates his or her account, or any time thereafter, the consumer may indicate one or more health goals that the consumer wants to achieve through the coaching system. In some embodiments, the consumer may be provided a survey that is used to assess the consumer's health and create a detailed user profile that is viewable by a coach. The detailed use profile may include personal goals that may be shared with the coach or other consumers. For example, the goal module 320 or the account module 304 may present twenty health questions and ask that the consumer to pick from a range of health goals, so that the coaching server 104 can, for example, provide a profile to the coach and set a daily calorie goal for the user.

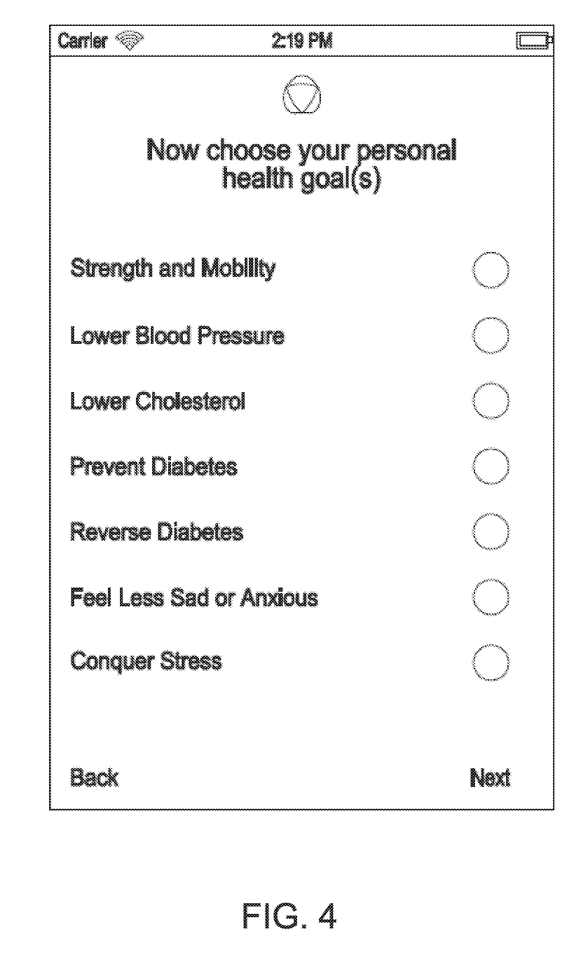

An example user interface illustrating a goal setting screen presented to a consumer is shown in FIG. 4. Examples of the health or fitness goals may include weight loss, lowering blood pressure, lowering cholesterol, preventing diabetes or its effects, reversing diabetes or its effects, managing stress or anxiety, or increasing strength and mobility. The consumer may select one or more of these health goals using the goal setting screen. While some examples of health goals are provided on the goal setting screen, other goals may be contemplated that are not shown. For example, the consumer may scroll through a list of health goals longer than that shown in FIG. 4. Alternatively, the user may manually enter one or more health or fitness goals. Further still, the health and fitness goals may be indicated by the health information received from the health provider system 110.

Returning to FIG. 3B, the goal module 320 may also determine daily goals for the consumer based on his or her indicated health goals. For example, the goal module 320 may determine a calorie goal for each day based on how much weight the consumer would like to lose per week in support of a higher or larger weight loss goal, such as a monthly goal or a goal to lose 100 pounds before the consumer's next birthday). A corresponding exercise program or plan may then be recommended so that the consumer can work the exercise program into his or her daily goals. For example, the exercise plan (or exercise goal) may suggest that the consumer exercise for half an hour every day.

The coach selection module 322 manages the assignment of a coach to the consumer. In some embodiments, the coach selection module 322 receives a request from a consumer looking for a coach, takes goals along with any preferences (e.g., location, gender, age, coaching style) provided by the consumer, and identifies coaches having a threshold amount (e.g., the most amount) of matching attributes to those goals and preferences from a coach database (e.g., on the data storage 112). In one embodiment, a health risk assessment, using the goals, is performed to map the consumer to a right set of coaches, in addition to mapping the consumer to digital therapeutics and protocols to recommend to the consumer. A list of coaches specializing in achieving the goals of the consumer may then be recommended by the coach selection module 322 to the consumer. The list may be limited to a predetermined number of top choices (e.g., top three coaches with the greatest number of attributes match to the consumer's goals).

In other embodiments, the request for a coach may be received from the health provider, system 110 on behalf of the consumer. For example, a doctor of the consumer may recommend that the consumer use the services of the coaching system, and may send a request for the consumer to be assigned a coach. The request from the health provider system 110 may include one or more goals for the consumer. The request may also provide preferences when selecting the coach. For example, the doctor may have a preference for a particular coaching style or coaches with certain certifications. If the consumer does not already have an account established with the coaching server 104, the consumer may be requested to create a new account by the account module 304.

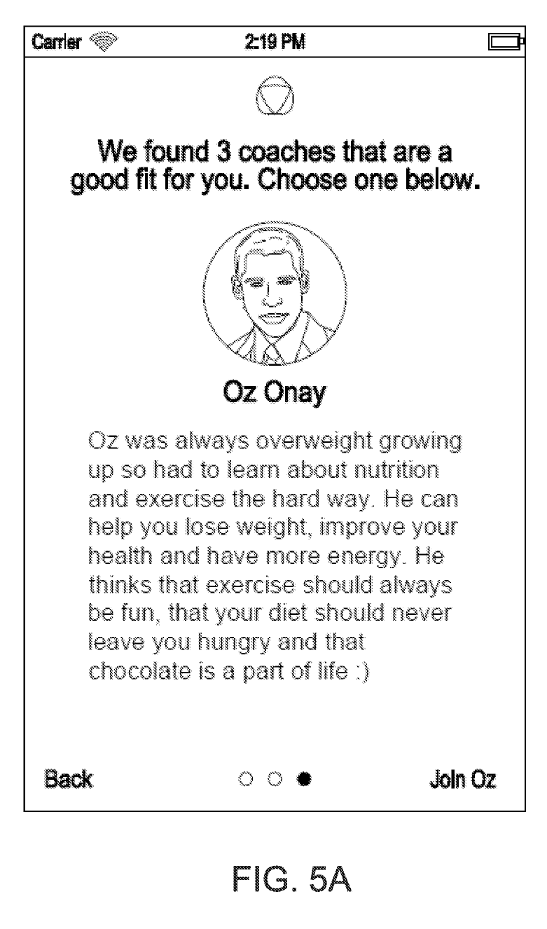

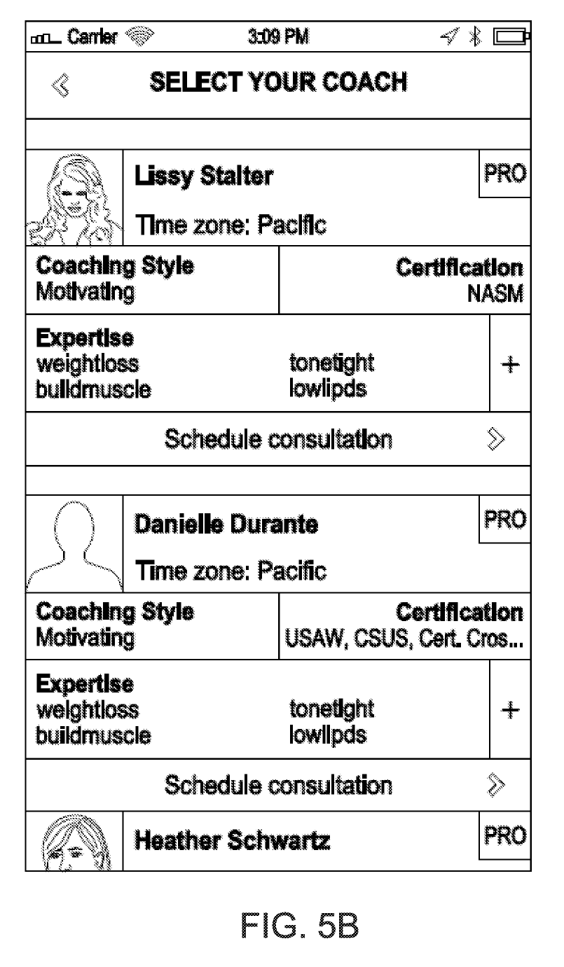

FIG. 5A is an example user interface illustrating a version of a coach recommendation screen presented to the consumer on the user device 102. In the example coach recommendation screen of FIG. 5A, a coach profile along with an image of the coach is provided to the consumer. The coach profile may describe facts, background, coaching style, and philosophy of the coach. The coach recommendation screen may also indicate a number of other coaches that are recommended to the consumer. In FIG. 5A, the consumer may view the recommended list of coaches by, for example, swiping left or right on a screen of the user device 102. The consumer may then select one of the coaches using a coach selection (e.g., a “Join Oz” button or other control)

FIG. 5B is an alternative user interface illustrating another version of a coach recommendation screen presented to the consumer on the user device 102. In the example coach recommendation screen of FIG. 5B, the recommended coaches are displayed in a scrollable format whereby the consumer may scroll up or down to view the details of the coaches. The coach recommendation screen may indicate a time zone, certifications, coaching style, and expertise of each of the recommended coaches.

In one embodiment, each consumer may receive a free consultation with a coach upfront and has to pay thereafter. The consumer may schedule the free consultation by selecting a “schedule consultation” selection (e.g., a “schedule consultation” button or other control). Consultations (whether paid or free) or coach conversations may be conducted via phone (e.g., facilitated by Twillio™) based on a scheduled appointment (e.g., scheduled using the coaching application 206 or the coach selection module 322). In some example embodiments, the coach conversation may be conducted via video (e.g., using a real-time Javascript application programming interface (API), such as webRTC). This may have the effect of providing a user with in-application video coaching. Further still, the consumer may message a coach at any time.

It is noted that while example embodiments of coach recommendation screens have been shown in FIG. 5A and FIG. 5B, alternative embodiments may contemplate other manners of presenting recommended coaches (e.g., list format or grid format). Additionally, any combination of information (e.g., expertise, certification, or background) may be presented with each recommended coach.

Returning to FIG. 3B, the team module 324 manages creation, monitoring, and data access of teams and their respective team members. In example embodiments, the coaching system supports a team structure and a follow structure. In certain example embodiments, the team may be created by the team module 324 assigning the consumer to a coach and a team being coached by the coach. In other example embodiments, the consumer may be placed on a team being coached by the coach that the consumer has selected from the list of recommended coaches. In yet other example embodiments, the consumer may pick their own team (e.g., without a coach). For example, the consumer may invite friends (e.g., via a social network) to join a team that the consumer is a member of. In another example embodiment, the consumer may receive an invitation to join a team by a member of the team. Further example embodiments may involve users being placed on a team with a coach based on their indicated goals (e.g., a team dedicated to weight loss).

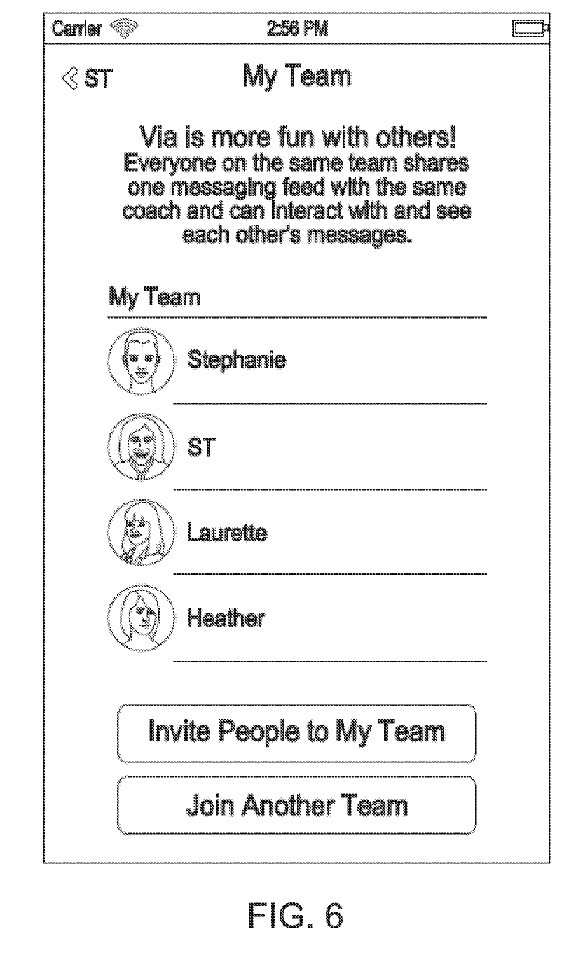

FIG. 6 is a user interface illustrating a team screen presented to the consumer on the user device 102. The team screen shows members of the team (e.g., “My Team”). A selection of any of the members on the team screen may bring up a status screen for the selected member. The team screen also comprises an “invite” button to invite other people to join the team. Selection of the “invite” button may trigger presentation of a screen that provides a list of friends or family (e.g., determined from a social network) to invite to join the team. Alternatively, the selection of the “invite” button may trigger presentation of a screen where the consumer may enter contact information for a friend or family member that the consumer would like to invite to join the team.

The team screen also provides a “join another team” button for the consumer to join another team. Selection of the “join another team” button may cause presentation of a screen that provides a list, of one or more other teams that the consumer may join. In example embodiments, the teams that the consumer may join may only include teams that have some sort of affiliation or connection with the consumer (e.g., teams with friends as member, teams with the same coach, teams with coworkers or other affiliations).

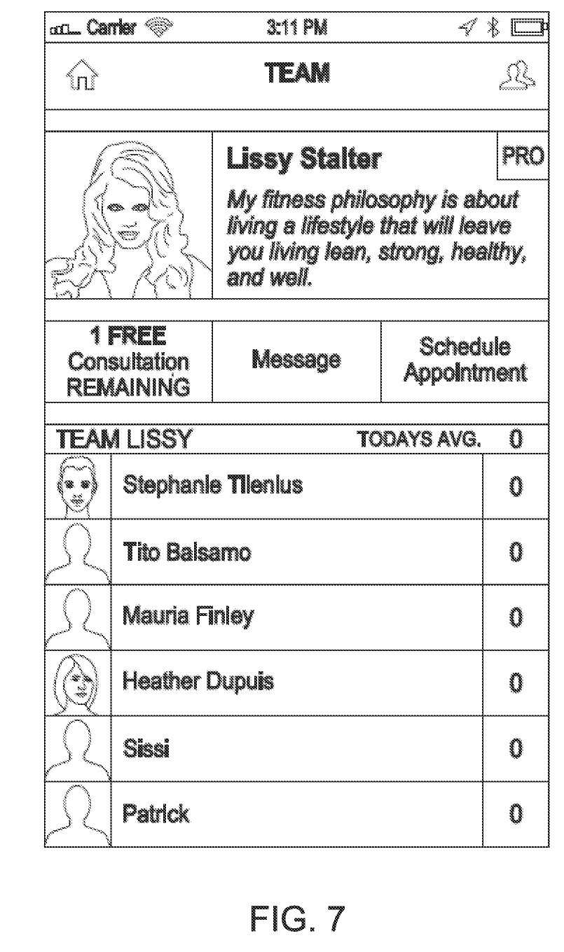

Referring to FIG. 7, another team screen presentable to the consumer is shown. The team screen of FIG. 7 is a team status screen. In example embodiments, members of the team can see status information, such as a daily score of each team member. In other example embodiments, other scores, statistics, or other status information for each member may be viewable by other members of the same team in the team status screen. In one example embodiment, each member may indicate which status information is private and not shared with other team members, and may indicate which status information is public and sharable with other team members or other designated individuals (e.g., family members, friends on social network).

The team module 324 (in conjunction with the messaging module 330) also allows members of the same team to message each other to share information. In one example embodiment, members of the team are provided a shared messaging feed with the selected coach, whereby messages sent by any member of the team is viewable by other members of the team (e.g., all other members of the team) and the coach.

The team module 324 may also allow consumers to follow other consumers of the coaching system that may not necessarily be on the same team. As such, the consumer can choose to follow another consumer of the coaching system and observe their behaviors and events. In one embodiment, the consumer may follow the selected other consumer in a social feed or messaging feed.

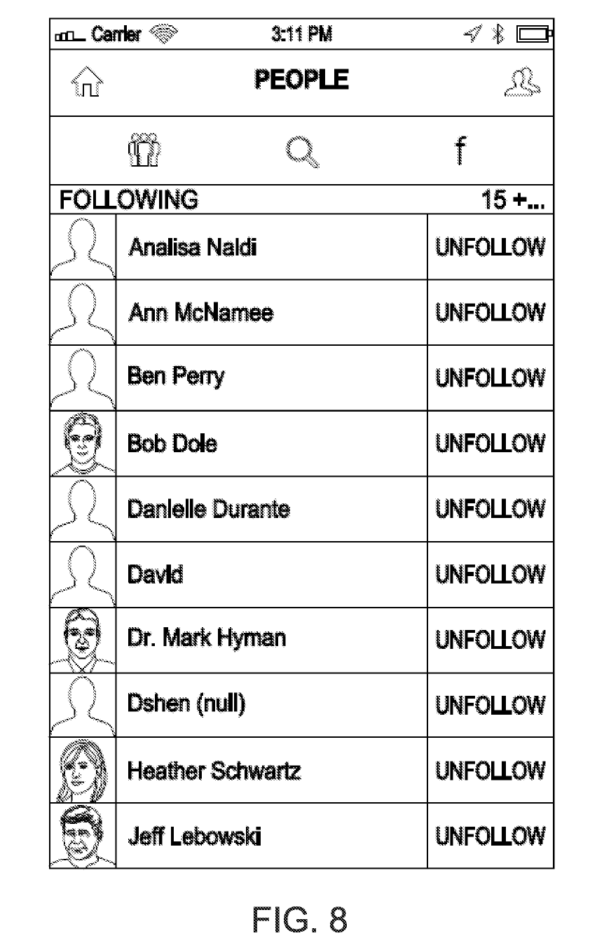

FIG. 8 is a user interface illustrating a following screen presented to the consumer. The following screen shows a list of other consumers that the consumer is following. By selecting one of the other consumers, the consumer to whom the user interface is presented may view the selected consumer's status information (e.g., food statistics, activity statistics, or sleep amount) which may include a daily score. However, in some example embodiments, individual daily scores may not be visible to the consumer to whom the user interface is presented unless the selected consumer is on the same team as the consumer. As discussed, according to various example embodiments, each consumer may indicate which of their status information is private and which of their status information is public and shareable. Additionally, each consumer may indicate different levels of public access. For example, only team members may be allowed to see weight loss status information for the consumer, but anyone following the consumer may be allowed to see their daily score.

The consumer may also “unfollow” another consumer. By selecting an “unfollow” selection, the unfollowed consumer is removed from the list of consumers being followed. In some cases, “unfollowing” another consumer may remove the unfollowed consumer from any teams that the consumer and the unfollowed consumer were both members of together.

The activity module 326 manages activity data provided to the coaching server 104. For example, the activity module 326 may log or store into data records linked to the user profile of the consumer any user inputs provided by the consumer via his or her coaching application 206. The user inputs include any activities performed by the consumer. The activities may include, for example, type and amount of food consumed, exercise performed along with duration, and amount of sleep obtained the night before. The activity module 326 may also log health information received from the health provider system 110.

In one embodiment, logging by the consumer may be performed through a “plus sign” in the coaching application (e.g., coaching application 206), which leads to a user interface for searching a database of food and exercise. The coaching application enables a user to log food a food entry-) from a food and restaurant database, as well as log exercise (e.g., an exercise entry) from an exercise database. Sleep may be logged manually as well (e.g., as a sleep entry). According to some example embodiments, passive data steps completed, miles walked, hours slept, or any suitable combination thereof) may be automatically uploaded and synchronized from a consumer's monitoring device (e.g., third party applications or connected devices, such as, Fitbit™, Withings™, Jawbone™, or other consumer devices or wearable devices) to the coaching server to a cloud that includes the coaching server 104).

Using the logged activity data along with indicated goals, the analysis module 310 performs an analysis to determine the status information for the consumer. The status information may indicate progress in reaching one or more goals indicated by the consumer. Additionally or alternatively, the scoring module 328 determines scores for the consumer based on the activity data logged by the activity module 326. In some example embodiments, a daily score of the consumer incorporating food, exercise, and sleep is generated by the scoring module 326. For example, the score may be 60% based on food, 30% based on exercise, and 10% based on sleep. Food scores, exercise scores, and sleep scores may be determined (e.g., from a lookup table for the particular food, exercise, amount of sleep) and then weighted accordingly. In some example embodiments, there is no maximum score. For example, the more a consumer exercises, the higher the score (e.g., without limit). Great eating days and great exercise days may yield a score of over a 100 in some cases. Good days may result in, for example, a score in the 80s. The scores may be shared with the coach, team members, and a health provider (e.g., consumer's doctor) via the health provider system 110,

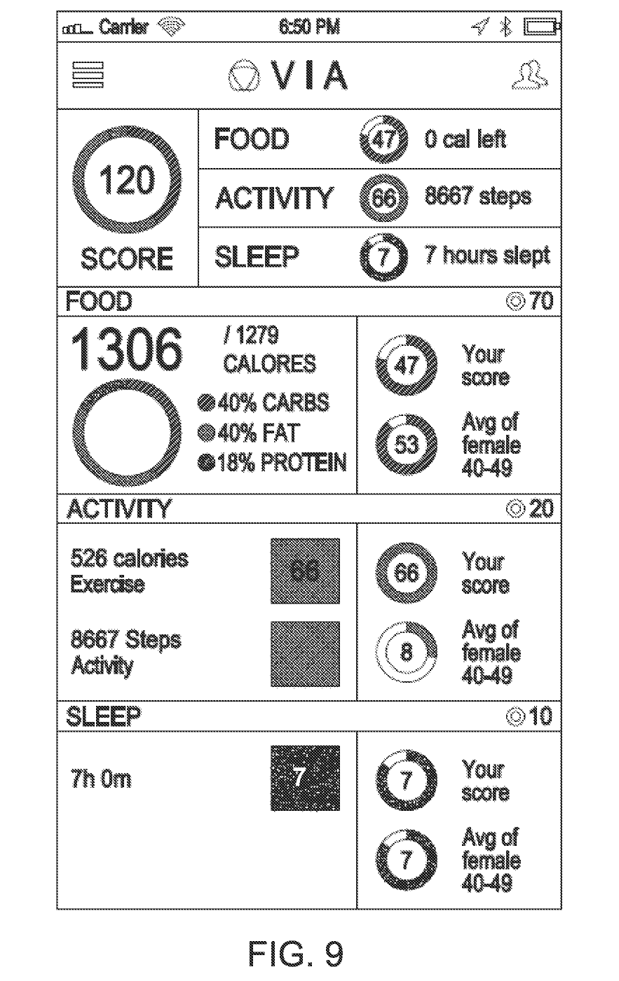

FIG. 9 is an interface diagram illustrating a status screen presented to the consumer, according to an example embodiment. The status screen may be presented via the communication module 302 from the analysis module 310 or another component of the consumer engine 306. The status screen shows a total score for the consumer (e.g., a total daily score of 120). Additionally, a breakdown of the total score may be shown. In the example of FIG. 9, the total score is derived from 47 points for food, 66 points for activity, and 7 points for sleep.

The status screen also shows a food portion that indicates a number of calories consumed along with percentages of carbohydrates, fat, and protein consumed for the day. The percentages may be color coordinated and shown graphically as well as with alphanumerical text. Additionally, a comparison of the consumer's food score to an average food score for similar consumers is presented in the status screen.

The status screen may also provide an activity portion that provides information related to exercise logged by the consumer for the day. In the present example shown, the consumer has burned 527 calories from exercise. In example embodiments where the consumer is monitoring his or her steps (e.g., by wearing a monitoring device), a number of steps taken may be presented in the status screen. Additionally, a comparison of the consumer's activity score to an average activity score for similar consumers is presented.

In a sleep portion of the status screen, a logged amount of time spent asleep is illustrated. Additionally, a comparison of the consumer's sleep score to an average sleep score for similar consumers is presented in the status screen. While the example of FIG. 9 shows specific status information, alternative embodiments may show other status information or present the status information in a different format.

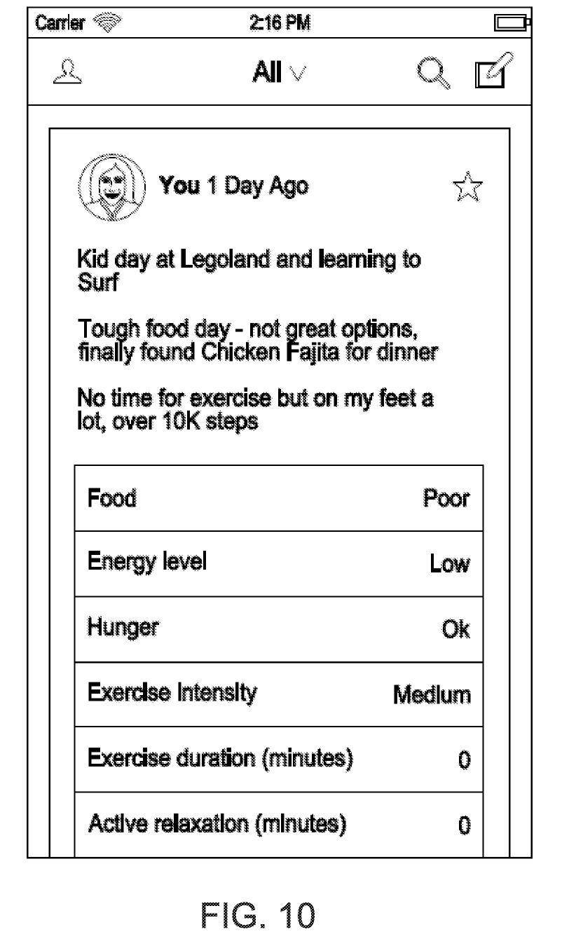

FIG. 10 is an interface diagram illustrating another status screen presented to the consumer, according to an example embodiment. The status screen of FIG. 10 shows status information for a past day. According to example embodiments, the consumer may review status information and logged entries of any selected day. Here, the consumer is viewing status information for the day before the present day. The status screen may provide an indication of how the consumer performed using text, numerical scores, time, color coding, or any other distinguishing mechanism. For example, the consumer's food status was poor indicating that the consumer may not have stuck to their diet or exceed calories or fat for the day. An energy level may be derived from activity information or other user inputs (e.g., direct comments by the consumer regarding energy). A hunger level may be derived from user inputs regarding when food was consumed and an amount consumed as well as from for example, direct user inputs or comments. Similarly, exercise intensity levels and duration may be derived from user inputs (e.g., logs of activity) or data from monitoring devices. Finally, an active relaxation level may indicate how many minutes the consumer relaxed on the particular day. While particular metric levels are shown in FIG. 10, alternative example embodiments may comprise less, more, or other metric levels on the status screen.

The status screen may also present comments that the consumer made for the particular day. In some example embodiments, the comments may be obtained from messages that the consumer sent (e.g., to the coach or other members). In other example embodiments, the comments may be provided directly by the consumer (e.g., a daily status entry).

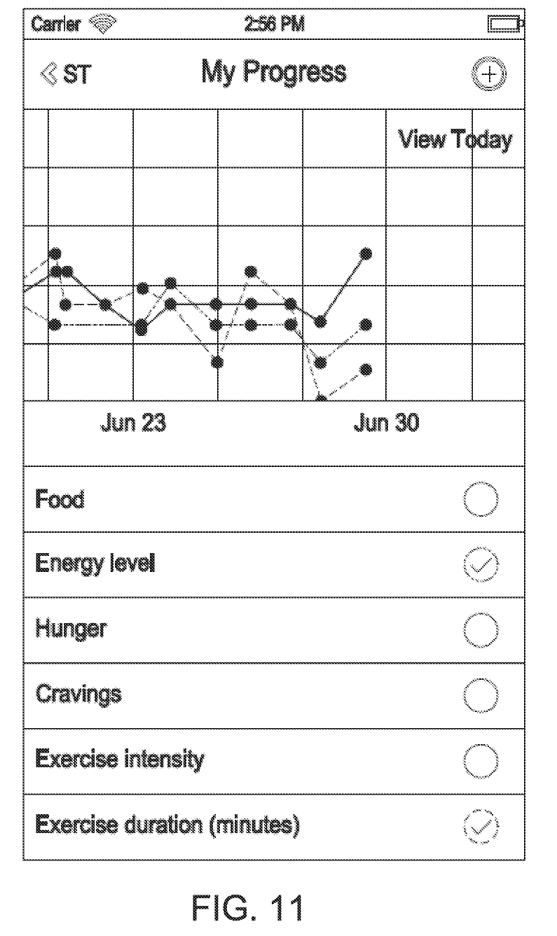

FIG. 11 is an interface diagram illustrating another status screen presented to the consumer, according to an example embodiment. The status screen of FIG. 11 provides an interactive status display. The consumer may select particular metrics to view status over time. For example, the consumer has selected energy level, exercise direction, and one other metric (shown below a screen but viewable if scrolled down). Each selection of a metric (e.g., with a check mark) may be a different color. A graph displayed at a top of the status screen shows status information or status levels over time for each of the selected metrics in the same color as the check mark. If the consumer selects a node on the graph, a new status screen may be provided that displays the detailed status information for the selected metric at the selected time. For example, if the consumer selects a particular food node, a status screen may be provided that provides details regarding a particular meal consumed at the time of the indicated node. The details may include type and amount of food consumed, number of calories, number of fat, number of protein, and where the food was consumer (e.g., name of a restaurant). In another example, if the consumer selects a particular exercise duration node, a status screen may be provided that indicates type of exercise and amount of time spent performing that exercise. Other information, such as calories burned may also be provided.

Returning to FIG. 3B, the messaging module 330 manages messages between the consumer and his or her coach and fellow team members. In some embodiments, the messaging module 330 may provide user interfaces that enable sending messages to and from the consumer. For example, the user interface may provide a list of individuals that the consumer may text (e.g., coach or team members) or automatically populate a field with an e-mail address of the coach of the consumer or a team member that the consumer communications with regularly. Further still, the messaging module 330 may provide a phone number or provide access to establish a video conference with the coach. The user interface may also display messages from the coach or display messages from particular team members.

The messaging module 330 may also maintain records or logs of the messages and may provide information from the messages to the scoring module 328 to be used in generating the scores or the analysis module 310 to generate status information. For example, the consumer may send a message (e.g., e-mail, text) to the coach indicating that the consumer has final run a 10 minute mile that day. The messaging module 328 may detect that information and provide it to the scoring module to calculate the activity score or provide the information to the analysis module 310 to generate status information.

The rewards module 332 manages offers or rewards presented to the consumer. The offers or rewards may be based on, for example, scores, teams, or employers. For example, the employer of the consumer may offer discounts to a particular gym or restaurant to the consumer. In another example, users that maintain a certain score for a predetermined amount of time (e.g., 3 days in a row) may be provided a reward such as a discount with a manufacturer or store (e.g., at a health food store), a free day at the gym, or with some other incentive. The reward module 332 may also manage competitions between individual consumers or teams to obtain a high score with winner(s) receiving rewards or prizes.

Referring now to FIG. 3C, a block diagram of the example coach engine 308 of the coaching server 104 is shown. The coach engine 308 manages functionalities related to the coach at the coaching server 104. Accordingly, the coach engine 308 may comprise a profile module 340, a tracking module 342, a messaging module 344, and a recommendation module 346, which may be communicatively coupled together.

The profile module 340 maintains a profile for each coach. When the coach initially creates an account with the coaching server 104, the coach may be presented with a questionnaire requesting the coach to indicate specialties, certifications, background, and other information that may be useful for a potential client (e.g., a consumer) to know about the coach (which may be collectively referred to as “attributes” of the coach). The answers to the questionnaire are used to generate a coach profile by the profile module 340. Additionally, using the answers to the questionnaire, the coaching server 104 (e.g., the coach selection module 322) may dynamically rank coaches for presentation to a consumer looking for a coach, based on the consumer's stated goals in their profile or survey (e.g., lose weight, get fit, be heart healthy, manage diabetes or a heart condition). The ranking may also take into consideration feedback from other consumers regarding each coach's engagement with consumers, behavior towards consumers, and outcome of other consumers using each coach.

The tracking module 342 manages presentation of status information of consumers to the coaches. In one embodiment, the tracking module 342 may provide a coaching website for coaches to view their consumer's profiles including status information. The tracking module 342 may also support a mobile version for the coaches to view consumer profiles using a mobile device. Coaches can view their clients' data, view their teams, view daily and team scores, make appointments, and so forth.

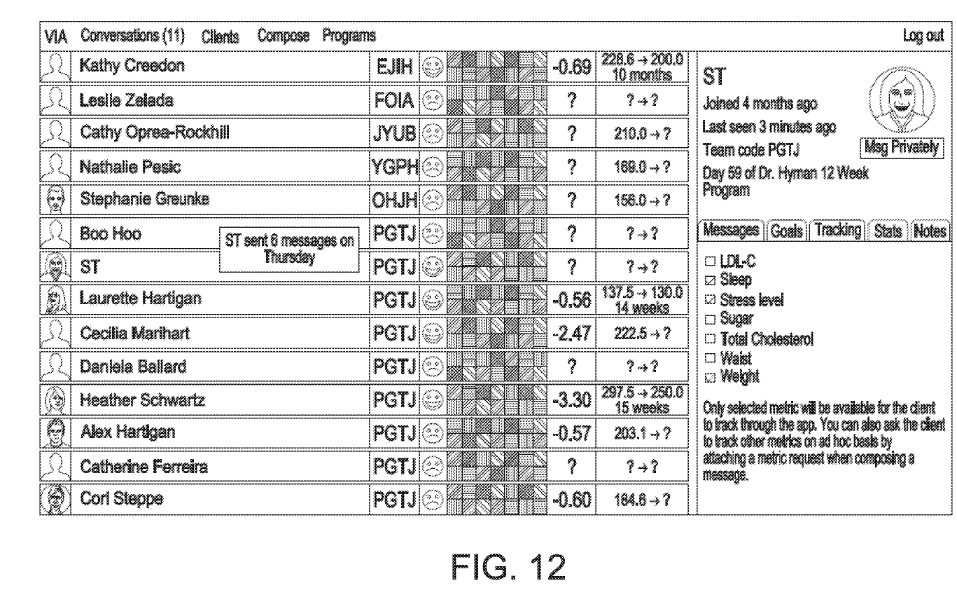

FIG. 12 shows a summary screen presented to the coach, according to an example embodiment. The summary screen of FIG. 12 shows the clients (e.g., consumers) that are being mentored by the coach. As such, the summary screen shown in FIG. 12 allows the coach to view a snapshot of some or of his or her clients. The coach may scroll through the list of the clients, sort the clients (e.g., by team, by name), and access more information for any one of the clients. The summary screen may provide an image of the client, name of the client, a team that the client is a member of, an indication of how engaged the client is with the coach (e.g., smiley face for engaged and unhappy face for not engaged), color coded indications of engagement over the last week (e.g., shaded or colored boxes), weight loss over the last week (e.g., presented numerically), and a prediction of how long it will take to reach a weight loss goal if that is one of the indicated goals by the consumer (e.g., from “297.5 to 250.00-15 weeks”). The prediction (e.g., time estimate) to reach a weight loss goal may be determined by the analysis module 310.

Alternative example embodiments may include inure, less, or other client information, or present the client information in a different format or manner. For example, if the summary screen included a set of consumers trying to manage diabetes, the weight loss information may be replaced with blood sugar level statistics. Accordingly, the tracking module 342 is modular and can be customized to an individual consumer and their stated goals. For example, a consumer that is diabetic may track blood sugar, while a consumer that has a weight loss goal without diabetes may not track blood sugar. As such, the tracking module 324 may modify the types of activities that it shows based on the goals of the consumer

Additionally, information may be presented if the coach hovers over or selects a particular client from the summary screen. For example, if the coach hovers over one of the color coded indications of engagement (e.g., the shaded boxes which each represents a day of the week), a bubble may indicate details of the engagement (e.g., “ST sent six messages on Thursday”).

Furthermore, additional information may be presented in side portion of the summary screen for the selected client. In the present example shown, the coach has selected ST to view additional information. The additional information may include when the ST joined the coaching system, a time ST last interacted with the coaching system (e.g., last seen), an indication of a team ST is a member of, and progress on any program that ST is following (e.g., Day 59 of Dr. Hyman 12 Week Program).

The side portion may provide various tabs that allow the coach to access more particular details of the client ST. For instance, the coach is currently viewing tracking data (e.g., has selected the “tracking” tab). The tracking data may indicate metrics that are being currently tracked by the client. In the present example, the metrics being tracked include sleep, stress level, and weight.

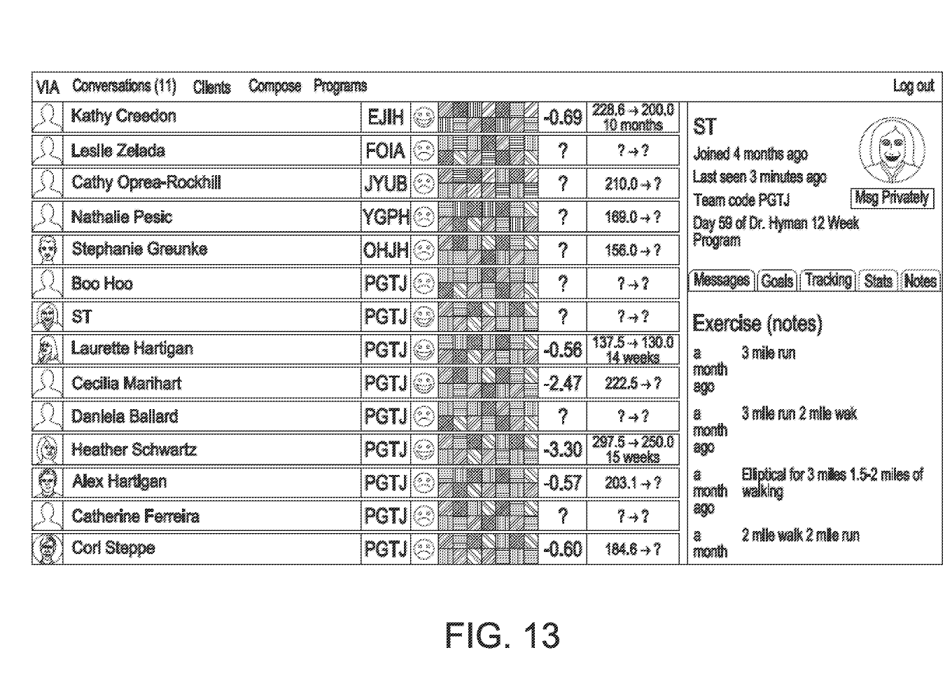

FIG. 13 is another summary screen presented to the coach, according to an example embodiment. In the summary screen of FIG. 13, the coach has now selected a “stats” tab to view exercise statistics or notes. As shown, the coach is scrolling through the statistics and arrived at exercise notes from a month ago. The notes may be, for example, derived by the analysis module 310 from user inputs, data from monitoring devices, or messages sent by the consumer.

The tracking module 342 (e.g., via the goal module 320) may also show in other summary screens or additional information portions of the summary screen, a breakdown of food consumed per day for a particular client (e.g., proteins, carbs, and fats consumed) and the client's daily food, exercise, and sleep scores. Additionally, the coaching server 104 may communicatively couple to third party applications (e.g., Fitbit™ Withings™) and other monitoring devices and external data (e.g., from the health provider server 110. Some or all of this information may be populated into an analytics dashboard for the user, and may be shared with the coach so that the coach can see the consumer's daily activities through the summary screen or other more detailed client screen.

It is noted that the summary screens presented in FIG. 12 and FIG. 13 are merely examples and that alternative embodiments may display other information, more information, less information, arrange the information in a different format or order, or use other display mechanisms (e.g., instead of smiley/unhappy faces using up/down arrows). Further still health information from different health provider systems of different consumers may be aggregated and presented to the coach on the summary screen, in a side portion of the summary screen, or on other screens provided to the coach that presents status information for a particular consumer. Additionally, the tabs for providing additional information may be different based on the goals of the consumers (e.g., consumers with weight loss goals may have different status information than consumers with heart health goals).

Referring back to FIG. 3C, the messaging module 344 manages messages to and from the coach. In some example embodiments, the messaging module 344 may provide a user interface that enables sending messages between the coach and his/her clients (e.g., the consumers). Additionally, the coaches may provide comments or encouragements (e.g., high-five) regarding a client's activity (e.g., congratulate on running the 10 minute mile), or recommend workouts or changes via the messaging module 344. The messaging module 344 allows the coach to be instantly accessible to his or her clients by texting phone, video conference, or any other form of communication,

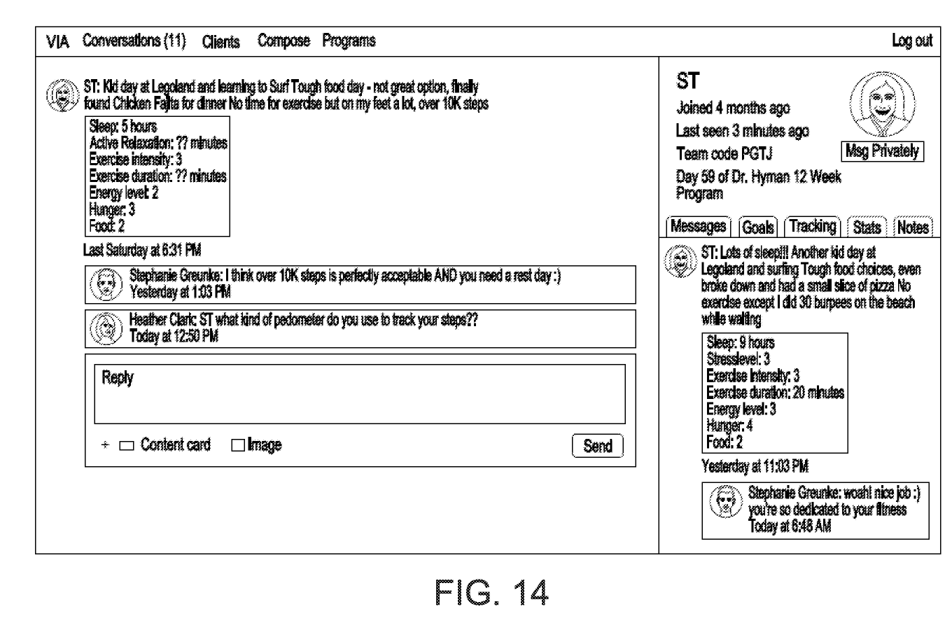

FIG. 14 illustrates an example messaging screen presented to the coach, according to an example embodiment. In the present example, the coach has selected a “messages” tab on a side portion of the user interface. The selection of the “messages” tab for the client ST brings up a messaging interface where the coach may view messages (e.g., text messages) exchanged with her client ST. In the present example shown, the coach may also see messages that the client exchanged with a fellow team member (e.g., Heather Clark). The coach may reply to a current message by entering a communication in a reply box and sending it.

Referring back to FIG. 3C, the recommendation module 346 manages recommendations by the coach. For example, the coach can recommend workouts, meal plans, diet changes, behavioral changes, health information, or any suitable combination thereof, to a client. The recommendations may be suggested by the recommendation module 345 to the coach based on user inputs, goals, monitored data, or health information. In one embodiment, a health risk assessment is performed, using the goals of the consumer, to map the consumer to digital therapeutics and protocols to recommend to the consumer. The coach may then select one or more of the recommendations presented by the recommendation module 346 and send it to the consumer in a message. The message may appear as if the coach has personally prepared the recommendation. For example, if the client wants to eat according to a Paleo or Vegan diet, the recommendation module 346 may recommend foods, recipes, or restaurants that fit that constraint. The recommendation module 346 may also make food and exercise recommendations to the client in real-time based on user behavior. For example, if a user has already logged exercise (e.g., a workout at a gym) in the morning, the recommendation module 346 may recommend a walk or yoga later in the day. If a user only slept 5 hours and then exercised (e.g., worked out), the recommendation module 346 may recommend eating a high protein breakfast to avoid crashing.

Additionally, user tips and insights may be provided via automated intelligence (AI) of the coaching system (e.g., the recommendation module 346) based on analyzed user data. As a result, the recommendation module 346 may suggest simple changes to hit stated health goals. In one example embodiment, the AI of the coaching system may use comparative population data and user-specific data to recommend general behavior changes, exercise changes, meal plans, dietary changes, and so forth.

The recommendation module 346 in conjunction with the messaging module 344 may recommend and send health or fitness information that has been created by the coaching system. In particular, the coaching system may maintain a library of a plurality, of content cards, for example, in the form of web interfaces that provide information on diets, health issues, exercise plans, or any other information that a coach may want to share with his or her clients. The coach may select one or more of these content cards and indicate which clients should receive the content cards and may even indicated when the content cards should be sent.

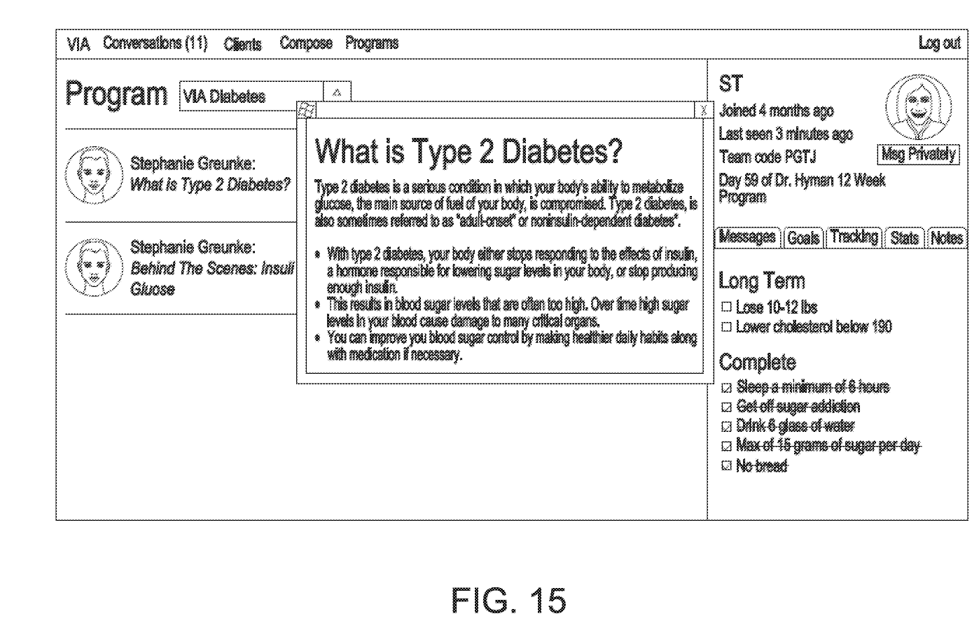

Referring to FIG. 15, a content card screen presented to a coach, according to an example embodiment, is shown. The content card screen shows an example of one content card that a coach may share. In the present example, the content card provides information regarding type 2 diabetes. The coach may select this content card for his or her client and may automatically share it (e.g., the recommendation module 346 causes the messaging module 344 to send) or manually share it (e.g., coach manually e-mails or messages it to the client directly). In some cases, the content card may include a video or other interactive features.

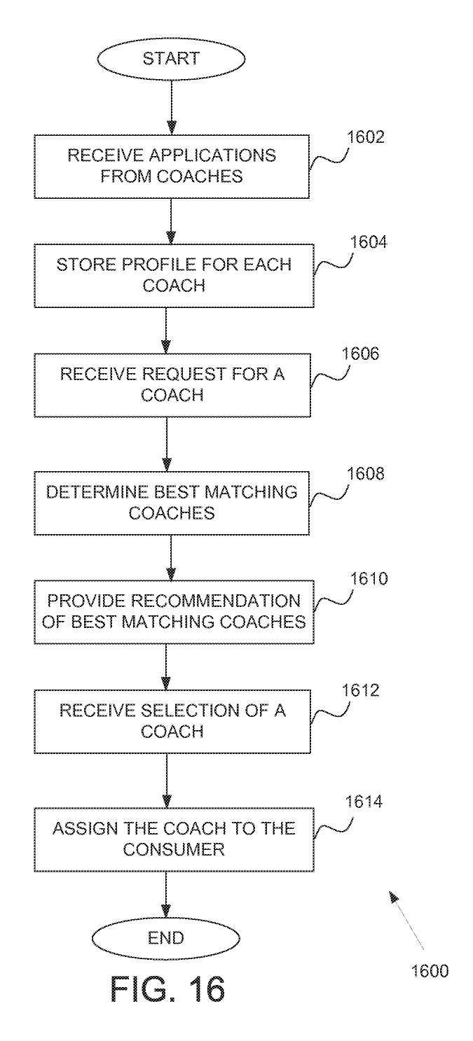

FIG. 16 is a flowchart of an example method 1600 of assigning a coach to a consumer. The method 1600 may be performed by various modules of the coaching server 104 in accordance with various example embodiments. In operation 1602, the coaching server 104 receives applications from coaches that want to be apart of the coaching system. In certain example embodiments, when the coach initially applies for and creates an account with the coaching server 104, the coach may be presented with a questionnaire (e.g., by the profile module 340 or account module 304) requesting the coach to indicate specialties, certifications, background, and other information that may be useful for a potential client (e.g., a consumer) to know about the coach. The answers to the questionnaire are used to generate a coach profile by the profile module 340.

In operation 1604, the coach profile may be stored for each coach. For example, the profile module 340 may generated and store the coach profile for each coach in a coach database at the data storage 112.

In operation 1606, a request for a coach is received. In example embodiments, a consumer may request a coach when they initially sign up for the coaching system. For example, the consumer may set up an account via the account module 304 and send a request for a coach to the coach selection module 322.

In operation 1608, the coaching server 104 determines best matching coaches for the requesting consumer. In example embodiments, the coach selection module 322 receives a request from the consumer looking for a coach, and takes health and physical fitness goals along with any preferences (e.g., location, gender, age, coaching style) provided by the consumer and identifies coaches having a most amount of matching attributes to those goals and preferences from the coach database (e.g., on the data storage 112). The coaches may be dynamically ranked for presentation to the requesting consumer, based on the consumer's stated health and fitness goals in their profile, survey (e.g., lose weight, get fit, be heart healthy), or request. The ranking may also take into consideration feedback from other consumers regarding each coach's engagement with consumers, behavior towards consumers, and outcome of other consumers using each coach. A list of coaches specializing in achieving the goals of the consumer may then be recommended by the coach selection module 322 to the consumer in operation 1610. The list may be sortable (e.g., by name, location, most matching)

In operation 1612, a selection of a coach is received from the consumer. The consumer may have reviewed the list of recommended coaches including coach profiles using their user device 102 and selected one of the coaches. The selection is received by the coach selection module 322.

In operation 1614, the selected coach is assigned to the consumer. Accordingly, the coach may be notified of his new client (e.g., the requesting consumer) and may start to exchange communications, advice, and status information with the consumer (e.g., via the various communication modules 202 and 302).

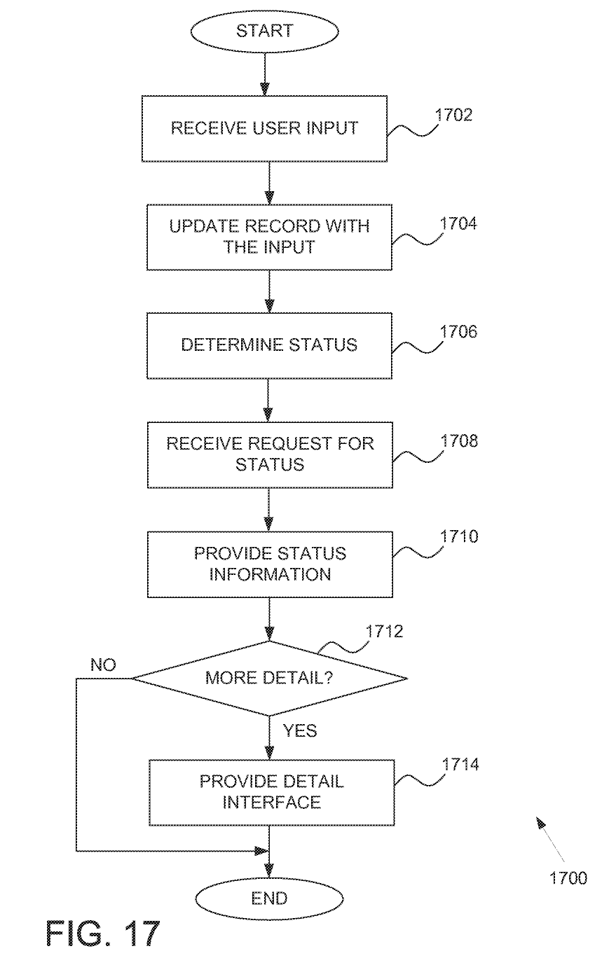

FIG. 17 is a flowchart of an example method 1700 of providing status and detail user interfaces (e.g., comprising status screens). In operation 1702, one or more user inputs are received from the consumer. For example, the consumer may manually enter information regarding food consumed or hours of sleep obtained via the interface module 212. Additionally, monitoring devices may automatically provide inputs (e.g., via the monitoring module 210). Further still, health information may be received from the health provider system 110. For example, if the consumer recently saw their doctor and had bloodwork done, the results may be received from the health provider system 110. In various example embodiments, the user inputs may be received by the activity module 326.

In operation 1704, a record associated with the consumer is updated with the received user inputs. In example embodiments, the activity module 326 log or store into data records linked to the user profile of the consumer any user inputs provided by the consumer via their coaching application. The user inputs include any activities performed by the consumer. The activities may include, for example, type and amount of food consumed, exercise performed along with duration, and amount of sleep obtained the night before. The activity module 326 may also log health information (also referred to as “user input) received from the health provider system 110. The health information may include biometrics, blood work, clinical data, phenotype data, longer term genomic data of the consumer, health and fitness recommendations for the consumer (e.g., from the consumer's doctor or based on tests performed by a health provider) including, for example, recommending health and fitness goals, exercise regiments, and dietary constraints.

In operation 1706, status is determined (or updated) for the consumer. Accordingly, the analysis module 310 may perform analysis of data such as user inputs provided by the consumer including health information provided by the health provider system 110 to determine status information for the consumer. The status information may indicate progress in reaching one or more goals indicated by the consumer. Additionally or alternatively, the scoring module 328 determines scores for the consumer based on the activity data logged by the activity module 326. In some embodiments, a daily score of the consumer incorporating food, exercise, and sleep is generated by the scoring module 326.

In operation 1708, a request for status is received. In some eases, the request may be received from the consumer via their user device 102. In other cases, the request may be received from the coach of the consumer via their coach device 108. Further still, the request may be received from followers or team members of the consumer. The request may be received by the communication module 302, of the coaching server 104.

In operation 1710, a user interface comprising a status screen or summary screen is provided to the requester (e.g., consumer, coach, or team member). In some embodiments, the analysis module 310 provides the status screens to the consumer or team members of the consumers. In other embodiments, the tracking module 342 may provide the status screens (e.g., summary screens) to the coach.

In operation 1712, a determination is made as to whether additionally details are requested. For example, the coach may, while viewing a summary screen request detailed information for a particular client. The request may be received by the tracking module 342. Alternatively, the consumer may select a node from a status screen to request additional details for a time and metric corresponding to the selected node. The request from the consumer may be received, for example, by the communication module 302 or another component of the coaching server 104 (e.g., the analysis module 310).

Based on the determination that more details are requested, a more detailed interface is provided in operation 1714. For example, if the consumer selects the node from the status screen, a new status screen may be provided that displays the detailed status information for the selected metric at the selected time. Alternatively, if the coach selects a particular tab for a selected client (e.g., on FIG. 12 or FIG. 13), details for metrics for the selected tab may be presented to the coach (e.g., by the tracking module 342.

Certain embodiments are described herein as including logic or a number of components, modules, or mechanisms. Modules may constitute software modules (e.g., code stored or otherwise embodied on a machine-readable medium or in a transmission medium), hardware modules, or any suitable combination thereof. A “hardware module” is a tangible (e.g., non-transitory) unit capable of performing certain operations and may be configured or arranged in a certain physical manner. In various example embodiments, one or more computer systems (e.g., a standalone computer system, a client computer system, or a server computer system) or one or more hardware modules of a computer system (e.g., a processor or a group of processors) may be configured by software (e.g., an application or application portion) as a hardware module that operates to perform certain operations as described herein.

In some embodiments, a hardware module may be implemented mechanically, electronically, or any suitable combination thereof. For example, a hardware module may include dedicated circuitry or logic that is permanently configured to perform certain operations. For example, a hardware module may be a special-purpose processor, such as a field programmable gate array (FPGA) or an ASIC. A hardware module may also include programmable logic or circuitry that is temporarily configured by software to perform certain operations. For example, a hardware module may include software encompassed within a general-purpose processor or other programmable processor. It will be appreciated that the decision to implement a hardware module mechanically, in dedicated and permanently configured circuitry, or in temporarily configured circuitry (e.g., configured by software) may be driven by cost and time considerations.

Accordingly, the phrase “hardware module” should be understood to encompass a tangible entity, and such a tangible entity may be physically constructed, permanently configured (e.g., hardwired), or temporarily configured (e.g., programmed) to operate in a certain manner or to perform certain operations described herein. As used herein, “hardware-implemented module” refers to a hardware module. Considering embodiments in which hardware modules are temporarily configured (e.g., programmed), each of the hardware modules need not be configured or instantiated at any one instance in time. For example, where a hardware module comprises a general-purpose processor configured by software to become a special-purpose processor, the general-purpose processor may be configured as respectively different special-purpose processors (e.g., comprising different hardware modules) at different times. Software (e.g., a software module) may accordingly configure one or more processors, for example, to constitute a particular hardware module at one instance of time and to constitute a different hardware module at a different instance of time.

Hardware modules can provide information to, and receive information from, other hardware modules. Accordingly, the described hardware modules may be regarded as being communicatively coupled. Where multiple hardware modules exist contemporaneously, communications may be achieved through signal transmission (e.g., over appropriate circuits and buses) between or among two or more of the hardware modules. In embodiments in which multiple hardware modules are configured or instantiated at different times, communications between such hardware modules may be achieved, for example, through the storage and retrieval of information in memory structures to which the multiple hardware modules have access. For example, one hardware module may perform an operation and store the output of that operation in a memory device to which it is communicatively coupled. A further hardware module may then, at a later time, access the memory device to retrieve and process the stored output. Hardware modules may also initiate communications with input or output devices, and can operate on a resource (e.g., a collection of information).

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions. The modules referred to herein may, in some example embodiments, comprise processor-implemented modules.

Similarly, the methods described herein may be at least partially processor-implemented. For example, at least some of the operations of a method may be performed by one or more processors or processor-implemented modules. The performance of certain of the operations may be distributed among the one or more processors, not only residing within a single machine, but deployed across a number of machines. In some example embodiments, due processor or processors may be located in a single location (e.g., within a home environment, an office environment or as a server farm), while in other embodiments the processors may be distributed across a number of locations.

The one or more processors may also operate to support performance of the relevant operations in a “cloud computing” environment or as a “software as a service” (SaaS). For example, at least some of the operations may be performed by a group of computers (as examples of machines including processors), these operations being accessible via a network (e.g., the Internet) and via one or more appropriate interfaces (e.g., Application Program Interfaces (APIs).)

Example embodiments may be implemented in digital electronic circuitry, or in computer hardware, firmware, software, or in combinations of them. Example embodiments may be implemented using a computer program product, a computer program tangibly embodied in an information carrier, e.g., in a machine-readable medium for execution by, or to control the operation of, data processing apparatus, e.g., a programmable processor, a computer, or multiple computers.

A computer program can be written in any form of programming language, including compiled or interpreted languages, and it can be deployed in any form, ding as a stand-alone program or as a module, subroutine, or other unit suitable for use in a computing environment. A computer program can be deployed to be executed on one computer or on multiple computers at one site or distributed across multiple sites and interconnected by a communication network.

In example embodiments, operations may be performed by one or more programmable processors executing a computer program to perform functions by operating on input data and generating output. Method operations can also be performed by, and apparatus of example embodiments may be implemented as, special purpose logic circuitry, e.g., a field programmable gate array (FPGA) or an application-specific integrated circuit (ASIC).

The computing system can include clients and servers. A client and server are generally remote from each other and typically interact through a communication network. The relationship of client and server arises by virtue of computer programs running on the respective computers and having a client-server relationship to each other. In embodiments deploying a programmable computing system, it will be appreciated that that both hardware and software architectures merit consideration. Specifically, it will be appreciated that the choice of whether to implement certain functionality in permanently configured hardware (e.g., an ASIC), in temporarily configured hardware (e.g., a combination of software and a programs programmable processor), or a combination of permanently and temporarily configured hardware may be a design choice. Below are set out hardware (e.g., machine) and software architectures that may be deployed, in various example embodiments.

FIG. 18 is a block diagram illustrating components of a machine 1800, according to some example embodiments, able to read instructions from a machine-readable medium (e.g., a non-transitory machine-readable medium, a machine-readable storage medium, a computer-readable storage medium, or any suitable combination thereof) and perform any one or more of the methodologies discussed herein. Specifically, FIG. 18 shows a diagrammatic representation of the machine 1800 in the example form of a computer system and within which instructions 1824 (e.g., software, a program, an application, an apples, an app, or other executable code) for causing the machine 1800 to perform any one or more of the methodologies discussed herein may be executed.

In alternative embodiments, the machine 1800 operates as a standalone device or may be connected (e.g., networked) to other machines. In a networked deployment, the machine 1800 may operate in the capacity of a server machine or a client machine in a server-client network environment, or as a peer machine in a peer-to-peer (or distributed) network environment. The machine 1800 may be a server computer, a client computer, a personal computer (PC), a tablet computer, a laptop computer, a netbook, a set-top box (STB), a personal digital assistant (PDA), a cellular telephone, a smartphone, a web appliance, a network router, a network switch, a network bridge, or any machine capable of executing the instructions 1824, sequentially or otherwise, that specify actions to be taken by that machine. Further, while only a single machine is illustrated, the term “machine” shall also be taken to include a collection of machines that individually or jointly execute the instructions 1824 to perform any one or more of the methodologies discussed herein.

The machine 1800 includes a processor 1802 (e.g., a central processing unit (CPU), a graphics processing unit (GPU), a digital signal processor (DSP), an application specific integrated circuit (ASIC), a radio-frequency integrated circuit (RFIC), or any suitable combination thereof), a main memory 1804, and a static memory 1806, which are configured to communicate with each other via a bus 1808. The processor 1802 may contain microcircuits that are configurable, temporarily or permanently, by some or all of the instructions 1824 such that the processor 1802 is configurable to perform any one or more of the methodologies described herein, in whole or in part. For example, a set of one or more microcircuits of the processor 1802 may be configurable to execute one or more modules (e.g., software modules) described herein.

The machine 1800 may further include a graphics display 1810 (e.g., a plasma display panel (PDP), a light emitting diode (LED) display, a liquid crystal display (LCD), a projector, or a cathode ray tube (CRT)). The machine 1800 may also include an alpha-numeric input device 1812 (e.g., a keyboard or keypad), a cursor control device 1814 (e.g., a mouse, a touchpad, a trackball, a joystick, a motion sensor, or other pointing instrument), a storage unit 1816, a signal generation device 1818 (e.g., a sound card, an amplifier, a speaker, a headphone jack, or any suitable combination thereof), and a network interface device 1820.

The storage unit 1816 includes a machine-readable medium 1822 (e.g., a tangible or non-transitory machine-readable storage medium) on which is stored the instructions 1824 embodying any one or more of the methodologies or functions described herein. The instructions 1824 may also reside, completely or at least partially, within the main memory 1804, within the processor 1802 (e.g., within the processor's cache memory), or both, during execution thereof by the machine 1800. Accordingly, the main memory 1804 and the processor 1802 may be considered as machine-readable media (e.g., tangible and/or non-transitory machine-readable media). The instructions 1824 may be transmitted or received over a network 1826 via the network interface device 1820. For example, the network interface device 1820 may communicate the instructions 1824 using any one or more transfer protocols (e.g., hypertext transfer protocol (HTTP)).

In some example embodiments, the machine 1800 may be a portable computing device, such as a smart phone or tablet computer, and have one or more additional input components 1830 (e.g., sensors or gauges). Examples of such additional input components 1830 include an image input component (e.g., one or more cameras), an audio input component (e.g., a microphone), a direction input component (e.g., a compass), a location input component (e.g., a global positioning system (GPS) receiver), an orientation component (e.g., a gyroscope), a motion detection component (e.g., one or more accelerometers), an altitude detection component (e.g., an altimeter), and a gas detection component (e.g., a gas sensor). Inputs harvested by any one or more of these input components may be accessible and available for use by any of the modules described herein.

As used herein, the term “memory” refers to a tangible machine-readable medium able to store data temporarily or permanently and may be taken to include, but not be limited to, random-access memory (RAM), read-only memory (ROM), buffer memory, flash memory, and cache memory. While the machine-readable medium 1822 is shown in an example embodiment to be a single medium, the term “machine-readable medium” should be taken to include a single medium or multiple media (e.g., a centralized or distributed database, or associated caches and servers) able to store instructions. The term “machine-readable medium” shall also be taken to include any medium, or combination of multiple media, that is capable of storing instructions for execution by a machine (e.g., machine 1800), such that the instructions, when executed by one or more processors of the machine (e.g., processor 1802), cause the machine 1800 to perform any one or more of the methodologies described herein. Accordingly, a “machine-readable medium” refers to a single storage apparatus or device, as well as “cloud-based” storage systems or storage networks that include multiple storage apparatus or devices. The term “machine-readable medium” shall accordingly be taken to include, but not be limited to, one or more data tangible (e.g., non-transitory) data repositories in the form of a solid-state memory, an optical medium, a magnetic medium, or any suitable combination thereof.

Furthermore, the machine-readable medium is non-transitory in that it does not embody a propagating signal. However, labeling the tangible machine-readable medium as “non-transitory” should not be construed to mean that the medium is incapable of movement the medium should be considered as being transportable from one physical location to another. Additionally, since the machine-readable medium is tangible, the medium may be considered to be a machine-readable device.

The instructions 1824 may further be transmitted or received over a communications network 1826 using a transmission medium via the network interface device 1820 and utilizing any one of a number of well-known transfer protocols (e.g., HTTP). Examples of communication networks include a local area network (LAN), a wide area network (WAN), the Internet, mobile telephone networks, POTS networks, and wireless data networks (e.g., WiFi and WiMAX networks). The term “transmission medium” shall be taken to include any intangible medium that is capable of storing, encoding, or carrying instructions for execution by the machine, and includes digital or analog communications signals or other intangible medium to facilitate communication of such software.

As used herein, the term “or” may be construed in either an inclusive or exclusive sense. Moreover, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein.

Although an embodiment has been described with reference to specific example embodiments, it will be evident that various modifications and changes may be made to these embodiments without departing from the broader spirit and scope of the inventive subject matter. Accordingly, the specification and drawings are to be regarded in an illustrative rather than a restrictive sense. The accompanying drawings that form a part hereof, show by way of illustration, and not of limitation, specific embodiments in which the subject matter may be practiced. The embodiments illustrated are described in sufficient detail to enable those skilled in the art to practice the teachings disclosed herein. Other embodiments may be utilized and derived therefrom, such that structural and logical substitutions and changes may be made without departing from the scope of this disclosure. This Detailed Description, therefore, is not to be taken in a limiting sense, and the scope of various embodiments is defined only by the appended claims, along with the full range of equivalents to which such claims are entitled.

Such embodiments of the inventive subject matter may be referred to herein, individually and/or collectively, by the term “invention” merely for convenience and without intending to voluntarily limit the scope of this application to any single invention or inventive concept if more than one is in fact disclosed. Thus, although specific embodiments have been illustrated and described herein, it should be appreciated that any arrangement calculated to achieve the same purpose may be substituted for the specific embodiments shown. This disclosure is intended to cover any and all adaptations or variations of various embodiments. Combinations of the above embodiments, and other embodiments not specifically described herein, will be apparent to those of skill in the art upon reviewing the above description.

What is claimed is:

1. A method comprising:
maintaining a coach database that includes a list of coaches and attributes associated with each coach on the list;
receiving a request for a coach, the request including at least one goal of a consumer;
determining, using a processor of a machine, a plurality of coaches specializing in achieving the at least one goal, the determining comprising performing a comparison between the attributes associated with each coach and the at least one goal of the consumer to identify one or more matches;
providing a recommendation that indicates at least some of the plurality of coaches; and
receiving a selection of the coach identified from among the at least some of the plurality of coaches indicated in the recommendation.

2. The method of claim 1, further comprising:
providing a questionnaire to each of the coaches, the questionnaire requesting the attributes to be associated with each of the coaches;
receiving a response to the questionnaire from each of the coaches, the response including the attributes to be associated with each of the coaches; and
storing the attributes in association with each the coaches in the coach database.

3. The method of claim 1, further comprising:
receiving a user input indicating an activity performed by the consumer; and
updating a record of the consumer with the user input, the record comprising the at least one goal and a plurality of user inputs.

4. The method of claim 3, further comprising determining a time estimate that indicates a period of time expected to reach a weight loss goal based on the plurality of user inputs.

5. The method of claim 3, further comprising determining a score for the consumer based on the plurality of user inputs and the at least one goal.

6. The method of claim 3, further comprising:
providing status information for display in an interface, the status information including a graph illustrating at least one metric associated with the user input, the graph including a plurality of nodes;
receiving a selection of a node from the plurality of nodes; and
providing details for the selected node of the at least one metric.

7. The method of claim 1, further comprising providing the selected coach with status information to be displayed as a summary screen, the summary screen providing a summary of status of each consumer being coached by the selected coach, the status of each consumer including an indication of a level of engagement by each consumer.

8. The method of claim 1, further comprising:
providing the selected coach with access to a plurality of content cards, each of content card providing health or fitness information;
receiving an indication from the selected coach to transmit at least one content card of the plurality of content cards to the consumer; and
transmitting the at least one content card to the consumer as a message from the selected coach.

9. The method of claim 1, further comprising providing a message interface to the selected coach, the message interface displaying one or more messages from the consumer, the message interface further providing the selected coach with a mechanism to send messages to the consumer.

10. The method of claim 1, further comprising:
receiving health information for the consumer from a health provider server; and
saving the health information in a record associated with the consumer.

11. The method of claim 10, wherein the health information comprises at least one selection from the group consisting of biometrics, blood work, clinical data, phenotypic and longer term genomic data.

12. The method of claim 10, further comprising performing a health risk assessment, using the at least one goal, to map the consumer to digital therapeutics and protocols to recommend to the consumer.

13. The method of claim 1, further comprising:
receiving an indication from the consumer to join a team, the team being coached by the selected coach; and
providing members of the team with a shared messaging feed with the selected coach, wherein messages sent by any member of the team is viewable by other members of the team.

14. The method of claim 13, further comprising:
determining a score for the team; and
providing a reward to the team based on the score.

15. A machine-readable medium having no transitory signals and storing instructions that, when executed by a processor of a machine, cause the machine to perform operations comprising:
maintaining a coach database that includes a list of coaches and attributes associated with each coach on the list;
receiving a request for a coach, the request including at least one goal of a consumer;
determining a plurality of coaches specializing in achieving the at least one goal, the determining comprising performing a comparison between the attributes associated with each coach and the at least one goal of the consumer to identify one or more matches;
providing a recommendation that indicates at least some of the plurality of coaches; and
receiving a selection of the coach identified from among the at least some of the plurality of coaches indicated in the recommendation.

16. The machine-readable medium of claim 15, wherein the operations further comprise:
receiving a user input indicating an activity performed by the consumer; and
updating a record of the consumer with the user input, the record comprising the at least one goal and a plurality of user inputs.

17. The machine-readable medium of claim 16, wherein the operations further comprise:
providing status information for display in an interface, the status information including a graph illustrating at least one metric associated with the user input, the graph including a plurality of nodes;
receiving a selection of a node from the plurality of nodes; and
providing details for the selected node of the at least one metric.

18. The machine-readable medium of claim 15, wherein the operations further comprise providing the selected coach with status information to be displayed as a summary screen, the summary screen providing a summary of status of each consumer being coached by the selected coach, the status of each consumer including an indication of a level of engagement by each consumer.

19. The machine-readable medium of claim 15, wherein the operations further comprise:
receiving an indication from the consumer to join a team, the team being coached by the selected coach; and
providing members of the team with a shared messaging feed with the selected coach, wherein messages sent by any member of the team is viewable by other members of the team.

20. A system comprising:
a data storage configured to maintain a coach database, the coach database including a list of coaches and attributes associated with each coach on the list; and
a hardware processor configured to include a coach selection module, the coach selection module to
receive a request for a coach, the request including at least one goal of a consumer;
determine a plurality of coaches specializing in achieving the at east one goal, a determination of the plurality of coaches comprising performing a comparison between the attributes associated with each coach and the at least one goal of the consumer to identify one or more matches;
provide a recommendation that indicates at least some of the plurality of coaches; and
receive a selection of the coach identified from among the at least some of the plurality of coaches indicated in the recommendation.
